(19) United States
(12) Patent Application Publication
(10) Pub. No.: US 2024/0253356 A1
(43) Pub. Date: Aug. 1, 2024

(54) LIQUID EJECTION DEVICE

(71) Applicant: SEIKO EPSON CORPORATION, Tokyo (JP)

(72) Inventors: Shunsuke KURAMATA, SHIOJIRI-SHI (JP); Toshio KUMAGA, SHIOJIRI-SHI (JP); Ken INOUE, SHIOJIRI-SHI (JP)

(21) Appl. No.: 18/425,641

(22) Filed: Jan. 29, 2024

(30) Foreign Application Priority Data
Jan. 31, 2023 (JP) 2023-012629

(51) Int. Cl. B41J 2/165

(52) U.S. Cl. CPC B41J 2/16505; B41J 2/16502

(57) ABSTRACT

A liquid ejection device is a liquid ejection device to which a liquid accommodation portion accommodating a liquid containing a solvent is attached, and includes a liquid ejection portion in which a nozzle that ejects the liquid is open, a cap that forms a space communicating with the nozzle by coming into contact with the liquid ejection portion, an atmosphere flow path coupled to the liquid accommodation portion and the cap, and a dehumidification portion that dehumidifies an atmosphere inside at least any one of the liquid accommodation portion, the cap, and the atmosphere flow path.

The present application is based on, and claims priority from JP Application Serial Number 2023-012629, filed Jan. 31, 2023, the disclosure of which is hereby incorporated by reference herein in its entirety.

### BACKGROUND

### 1. Technical Field

The present disclosure relates to a liquid ejection device.

### 2. Related Art

JP-A-2004-122543 describes a liquid ejection device including a liquid ejection portion that ejects a liquid containing a solvent and a cap that comes into contact with the liquid ejection portion. The cap moisturizes the liquid ejection portion by coming into contact with the liquid ejection portion in a state in which a vaporized solvent is supplied.

The present inventors have discovered that a liquid containing a solvent has hygroscopicity and that, when the liquid containing a solvent contains water, a pigment in the liquid becomes foreign matter. Therefore, when an atmosphere inside the cap contains water, there is concern that a nozzle will become clogged due to the pigment in the liquid in the nozzle becoming foreign matter.

### SUMMARY

A liquid ejection device that solves the above problem is a liquid ejection device to which a liquid accommodation portion configured to accommodate a liquid containing a solvent is attached, the liquid ejection device including a liquid ejection portion in which a nozzle configured to eject the liquid opens, a cap configured to form a space communicating with the nozzle by coming into contact with the liquid ejection portion, an atmosphere flow path coupled to the liquid accommodation portion and the cap, and a dehumidification portion configured to dehumidify an atmosphere inside at least any one of the liquid accommodation portion, the cap, and the atmosphere flow path.

### BRIEF DESCRIPTION OF THE DRAWINGS

FIG. 1 is a schematic diagram illustrating a first embodiment of a liquid ejection device.

FIG. 2 is a schematic diagram at the time of capping.

FIG. 3 is a schematic diagram illustrating a second embodiment of the liquid ejection device.

FIG. 4 is a schematic diagram illustrating a third embodiment of the liquid ejection device.

FIG. 5 is a schematic diagram illustrating a fourth embodiment of the liquid ejection device.

FIG. 6 is a schematic diagram illustrating a modification example of the liquid ejection device.

FIG. 7 is a schematic diagram illustrating a modification example different from FIG. 6.

FIG. 8 is a schematic diagram illustrating a modification example different from FIGS. 6 and 7.

### DESCRIPTION OF EMBODIMENTS

Hereinafter, an embodiment of a liquid ejection device will be described with reference to the drawings. The liquid ejection device is, for example, an inkjet printer that prints images such as text and photographs by ejecting ink, which is an example of liquid, onto a medium such as paper or cloth. The liquid is an ink in which a solvent is a main solvent and a pigment is ink dispersed in the solvent and is so-called eco-solvent ink.

### First Embodiment

### Liquid Ejection Device

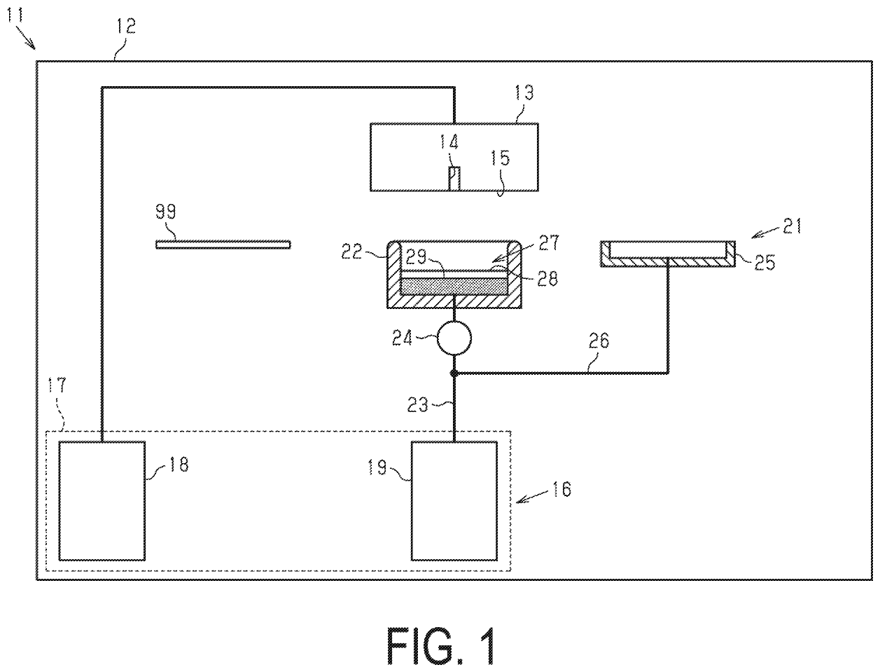

As illustrated in FIG. 1, a liquid ejection device 11 includes a housing 12.

The liquid ejection device 11 includes a liquid ejection portion 13. The liquid ejection portion 13 is configured to eject liquid. A nozzle 14 opens in the liquid ejection portion 13. Specifically, the liquid ejection portion 13 includes a nozzle surface 15 on which one or more nozzles 14 are open. The liquid ejection portion 13 ejects the liquid from the nozzle 14. The liquid ejection portion 13 prints an image on a medium 99 by ejecting the liquid onto the medium 99.

One or more liquid accommodation portions 16 are attached to the liquid ejection device 11. The liquid ejection device 11 includes, for example, a mounting portion 17. The mounting portion 17 is configured so that the liquid accommodation portion 16 is mounted on the mounting portion 17.

The liquid accommodation portion 16 accommodates a liquid containing a solvent. The liquid accommodation portion 16 is, for example, a cartridge or a tank. The liquid accommodation portion 16 is detachable from the mounting portion 17. The liquid accommodation portion 16 is accommodated in the housing 12 by being mounted on the mounting portion 17. The liquid accommodation portion 16 may be fixed in the liquid ejection device 11. That is, the liquid ejection device 11 may include the liquid accommodation portion 16.

A printing accommodation portion 18 is mounted on the mounting portion 17 as an example of the liquid accommodation portion 16. The printing accommodation portion 18 accommodates liquid used for printing. The printing accommodation portion 18 is coupled to the liquid ejection portion 13 by being mounted on the mounting portion 17. The liquid accommodated in the printing accommodation portion 18 is supplied to the liquid ejection portion 13. The printing accommodation portion 18 is not limited to being mounted on the mounting portion 17, and may be mounted on the liquid ejection portion 13, for example.

A moisturizing accommodation portion 19 is mounted on the mounting portion 17 as an example of the liquid accommodation portion 16. The moisturizing accommodation portion 19 accommodates liquid used for moisturization. The moisturizing accommodation portion 19 is coupled to a maintenance mechanism 21, which will be described below, by being mounted on the mounting portion 17. The liquid accommodated in the moisturizing accommodation portion 19 evaporates inside the moisturizing accommodation portion 19. As a result, the solvent vaporized within the moisturizing accommodation portion 19 is supplied to the maintenance mechanism 21.

The moisturizing accommodation portion 19 is a waste liquid accommodation portion that accommodates waste liquid discharged from the nozzle 14 according to maintenance. Therefore, as the waste liquid evaporates, the vaporized solvent is supplied to the maintenance mechanism 21. That is, the waste liquid is reused. The moisturizing accommodation portion 19 is not limited to a waste liquid accommodation portion, and may be a moisturizing liquid accommodation portion that accommodates a liquid dedicated to moisturization.

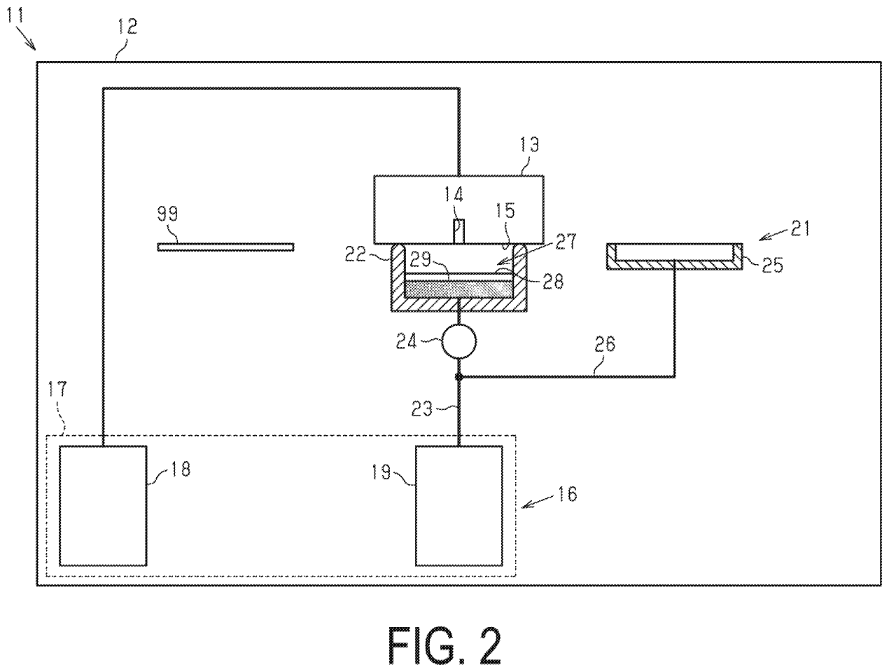

As illustrated in FIGS. 1 and 2, the liquid ejection device 11 includes a maintenance mechanism 21. The maintenance mechanism 21 is configured to maintain the liquid ejection portion 13. The maintenance mechanism 21 maintains or recovers the ejection performance of the liquid ejection portion 13 by maintaining the liquid ejection portion 13. The maintenance mechanism 21 maintains the liquid ejection portion 13 by, for example, capping, flushing, or cleaning.

Capping is an operation in which the maintenance mechanism 21 covers the nozzle 14. The nozzle 14 is moisturized by the capping. This reduces concern that the nozzle 14 will become clogged. The maintenance mechanism 21 maintains the liquid ejection portion 13 by capping the liquid ejection portion 13.

The flushing is an operation in which liquid is appropriately discharged from the nozzle 14. The flushing reduces the concern that the nozzle 14 will become clogged. The maintenance mechanism 21 maintains the liquid ejection portion 13 by receiving liquid through flushing. The liquid discharged by flushing is waste liquid.

The cleaning is an operation in which liquid is forcibly discharged from the nozzle 14. By cleaning, air bubbles, foreign matter, or the like is discharged from the nozzle 14 along with the liquid. The cleaning includes, for example, pressurized cleaning and suction cleaning. The pressurized cleaning is an operation of discharging the liquid from the nozzles 14 by pressurizing the inside of the liquid ejection portion 13. The suction cleaning is an operation of discharging the liquid from the nozzles 14 by suctioning the inside of the liquid ejection portion 13. The maintenance mechanism 21 maintains the liquid ejection portion 13 by receiving liquid through cleaning. The liquid discharged by cleaning is the waste liquid.

The maintenance mechanism 21 includes a cap 22. The cap 22 forms a space communicating with the nozzle 14 by coming into contact with the liquid ejection portion 13. That is, the cap 22 caps the liquid ejection portion 13. In one example, the cap 22 covers the nozzle 14 by coming into contact with the nozzle surface 15. In capping, the liquid ejection portion 13 may approach the cap 22, or the cap 22 may approach the liquid ejection portion 13.

The cap 22 may receive the waste liquid from the nozzle 14. The cap 22 may receive the liquid discharged by cleaning, for example. The cap 22 may receive the liquid discharged by flushing, for example.

The maintenance mechanism 21 includes an atmosphere flow path 23. The atmosphere flow path 23 is coupled to the cap 22 and the liquid accommodation portion 16. In one example, the atmosphere flow path 23 is coupled to the cap 22 and the moisturizing accommodation portion 19. Accordingly, the vaporized solvent is supplied from the moisturizing accommodation portion 19 into the cap 22 through the atmosphere flow path 23. As a result, the atmosphere inside the cap 22 contains the vaporized solvent. Since the atmosphere inside the cap 22 contains the vaporized solvent, the nozzle 14 is effectively moisturized in capping.

The waste liquid received by the cap 22 flows to the moisturizing accommodation portion 19 through the atmosphere flow path 23. The waste liquid received by the cap 22 may flow to the moisturizing accommodation portion 19 through a flow path different from the atmosphere flow path 23. The atmosphere flow path 23 may be coupled to the cap 22 and the printing accommodation portion 18. In this case, the vaporized solvent is supplied into the cap 22 from the printing accommodation portion 18.

The maintenance mechanism 21 may include a suction portion 24. The suction portion 24 is configured to suck the inside of the cap 22. In one example, the suction portion 24 is located in the atmosphere flow path 23. The suction portion 24 is, for example, a tube pump. The suction portion 24 sucks the liquid discharged from the nozzle 14 to the cap 22. Suction cleaning is executed by the suction portion 24 sucking the inside of the cap 22 in a state in which the cap 22 caps the liquid ejection portion 13. When the suction portion 24 sucks the inside of the cap 22 in a state in which the inside of the cap 22 is open, the waste liquid received by the cap 22 flows to the moisturizing accommodation portion 19. Therefore, the moisturizing accommodation portion 19 accommodates the liquid sucked by the suction portion 24.

The maintenance mechanism 21 may include a receiving portion 25. The receiving portion 25 is configured to receive the liquid discharged from the liquid ejection portion 13. Specifically, the receiving portion 25 receives the liquid through flushing. The receiving portion 25 is, for example, a tray or a box.

The maintenance mechanism 21 may include a coupling flow path 26. The coupling flow path 26 is coupled to the receiving portion 25. In one example, the coupling flow path 26 is coupled to the atmosphere flow path 23. Specifically, the coupling flow path 26 is coupled between the suction portion 24 and the moisturizing accommodation portion 19 in the atmosphere flow path 23. The waste liquid received by the receiving portion 25 flows to the moisturizing accommodation portion 19 through the coupling flow path 26. Therefore, the moisturizing accommodation portion 19 accommodates the liquid received by the receiving portion 25.

The coupling flow path 26 may be coupled between the cap 22 and the suction portion 24 in the atmosphere flow path 23. By the coupling flow path 26 being coupled to the atmosphere flow path 23, it is easy for the vaporized solvent to be supplied from the moisturizing accommodation portion 19 to the cap 22. The coupling flow path 26 is not limited to being coupled to the atmosphere flow path 23, and may be coupled to the moisturizing accommodation portion 19.

### Dehumidification Portion

The maintenance mechanism 21 includes a dehumidification portion 27. The dehumidification portion 27 is configured to dehumidify the atmosphere. The dehumidification portion 27 dehumidifies the atmosphere inside at least any one of the liquid accommodation portion 16, the cap 22, and the atmosphere flow path 23. The dehumidification portion 27 dehumidifies, for example, the atmosphere inside at least any one of the moisturizing accommodation portion 19, the cap 22, and the atmosphere flow path 23.

The dehumidification portion 27 dehumidifies the atmosphere inside the cap 22 by dehumidifying the atmosphere inside at least any one of the moisturizing accommodation portion 19, the cap 22, and the atmosphere flow path 23. Since the moisturizing accommodation portion 19, the cap 22, and the atmosphere flow path 23 are coupled to each other, the atmosphere inside the cap 22 is dehumidified by the dehumidification portion 27 dehumidifying any one of the atmospheres. Accordingly, the atmosphere inside the cap 22 contains the vaporized solvent and is brought into a dehumidified state.

The liquid has hygroscopicity. When a liquid contains water vapor in the air, a pigment in the liquid swells or condenses, and there is concern that the pigment becomes foreign matter. Therefore, when the liquid located in the nozzle 14 contains water, there is concern that the nozzle 14 is clogged. Therefore, when the atmosphere inside the cap 22 contains the water in capping, there is concern that the nozzle 14 is clogged.

It is easy for the liquid accommodated in the liquid accommodation portion 16 and, particularly, the liquid accommodated in the moisturizing accommodation portion 19 to contain the water vapor in the air. This is because the moisturizing accommodation portion 19 is open to the atmosphere. Further, the liquid accommodated in the moisturizing accommodation portion 19 may contain the water vapor when the water vapor in the air passes through the moisturizing accommodation portion 19, the atmosphere flow path 23, and the like. Therefore, it is easy for water vapor to be supplied from the moisturizing accommodation portion 19 to the cap 22 together with the vaporized solvent. Therefore, it is important to dehumidify the atmosphere inside the cap 22.

The dehumidification portion 27 includes a dehumidifier accommodation portion 28. The dehumidifier accommodation portion 28 is configured to accommodate a dehumidifier 29. The dehumidifier 29 is, for example, silica gel or molecular sieve. The dehumidifier accommodation portion 28 is located in the cap 22. Specifically, the dehumidifier accommodation portion 28 is a concave portion formed in the cap 22. That is, in one example, it can be said that the cap 22 includes the dehumidification portion 27. The dehumidifier accommodation portion 28 is located inside the cap 22. The dehumidifier accommodation portion 28 dehumidifies the atmosphere inside the cap 22 using the dehumidifier 29. Accordingly, the atmosphere inside the cap 22 contains the vaporized solvent and is brought into a dehumidified state.

The dehumidifier accommodation portion 28 is located so that the waste liquid received by the cap 22 comes into contact with the dehumidifier 29. That is, the waste liquid received by the cap 22 passes through the dehumidifier accommodation portion 28. The dehumidifier 29 is spread over the dehumidifier accommodation portion 28. The dehumidifier accommodation portion 28 can be replenished with the dehumidifier 29. The dehumidifier accommodation portion 28 is not limited to being located so that the waste liquid received by the cap 22 comes into contact with the dehumidifier 29, but may be located so that the waste liquid received by the cap 22 does not come into contact with the dehumidifier 29. For example, the dehumidifier accommodation portion 28 may be a pocket that communicates with a space inside the cap 22.

### Operation and Effects

Next, an operation and effects of the liquid ejection device 11 described above will be described.

(1-1) The dehumidification portion 27 dehumidifies the atmosphere inside at least any one of the liquid accommodation portion 16, the cap 22, and the atmosphere flow path 23. According to the above configuration, the vaporized solvent is supplied from the liquid accommodation portion 16 to the cap 22 through the atmosphere flow path 23. Since the liquid accommodation portion 16, the cap 22, and the atmosphere flow path 23 are coupled to each other, the atmosphere inside the cap 22 is dehumidified by the dehumidification portion 27 dehumidifying any one of the atmospheres. Therefore, the atmosphere inside the cap 22 contains the vaporized solvent and is brought into a dehumidified state. Therefore, the concern that the nozzle 14 will become clogged is reduced.

(1-2) The liquid accommodation portion 16 accommodates the liquid sucked by the suction portion 24 located in the atmosphere flow path 23. According to the above configuration, the nozzle 14 can be moisturized by the solvent contained in the liquid discharged to the cap 22. That is, the liquid discharged to the cap 22 can be reused for moisturization of the nozzle 14.

(1-3) The liquid accommodation portion 16 accommodates the liquid received by the receiving portion 25. According to the above configuration, the nozzle 14 can be moisturized by the solvent contained in the liquid received by the receiving portion 25. That is, the liquid received by the receiving portion 25 can be reused for moisturization of the nozzle 14.

(1-4) The dehumidifier accommodation portion 28 is located in the cap 22. According to the above configuration, the atmosphere inside the cap 22 can be dehumidified by the dehumidifier 29. Accordingly, the atmosphere inside the cap 22 is effectively dehumidified.

### Second Embodiment

Next, a second embodiment of the liquid ejection device 11 will be described. In the second embodiment, differences from the first embodiment described above will be mainly described.

### Suction Flow Path

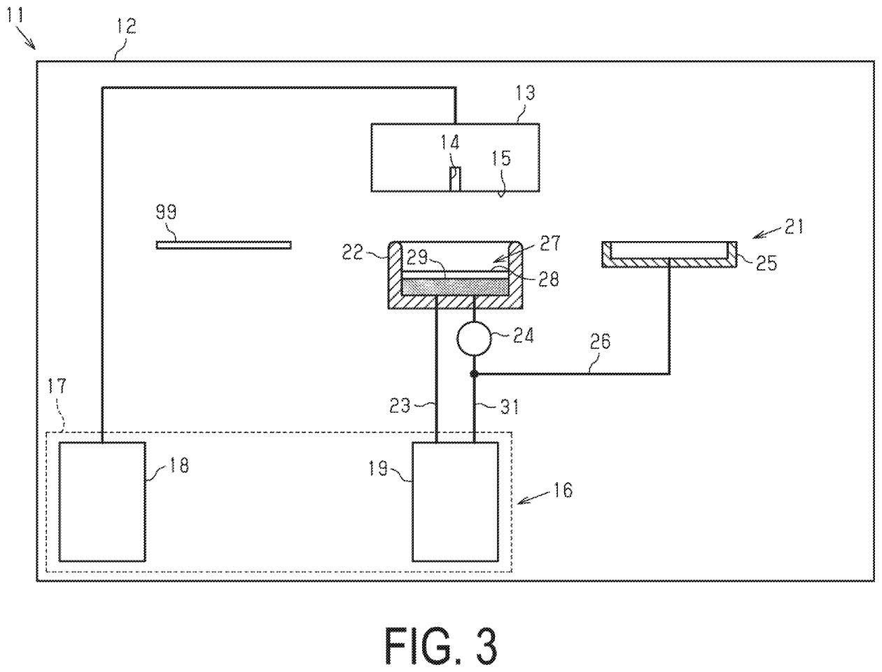

As illustrated in FIG. 3, the maintenance mechanism 21 may include a suction flow path 31. The suction flow path 31 is coupled to the liquid accommodation portion 16 and the cap 22. Specifically, the suction flow path 31 is coupled to the moisturizing accommodation portion 19 and the cap 22. In the second embodiment, the suction portion 24 is located in the suction flow path 31, unlike the first embodiment. The coupling flow path 26 is coupled to the receiving portion 25 and the suction flow path 31. The waste liquid received by the cap 22 is accommodated in the moisturizing accommodation portion 19 through the suction flow path 31. The waste liquid received by the receiving portion 25 is accommodated in the moisturizing accommodation portion 19 through the coupling flow path 26 and the suction flow path 31. That is, in the second embodiment, a flow path through which the vaporized solvent is supplied to the cap 22 and a flow path through which the waste liquid flows from the cap 22 are separated.

### Operation and Effects

Next, an operation and effects of the liquid ejection device 11 described above will be described.

(2-1) The liquid accommodation portion 16 accommodates the liquid sucked by the suction portion 24 located in the suction flow path 31. According to the above configuration, the nozzle 14 can be moisturized by the solvent contained in the liquid discharged to the cap 22. That is, the liquid discharged to the cap 22 can be reused for moisturization of the nozzle 14.

(2-2) The liquid accommodation portion 16 accommodates the liquid received by the receiving portion 25. According to the above configuration, the nozzle 14 can be moisturized by the solvent contained in the liquid received by the receiving portion 25. That is, the liquid received by the receiving portion 25 can be reused for moisturization of the nozzle 14.

### Third Embodiment

Next, a third embodiment of the liquid ejection device 11 will be described. In the third embodiment, differences from the first embodiment described above will be mainly described.

### Dehumidification Portion

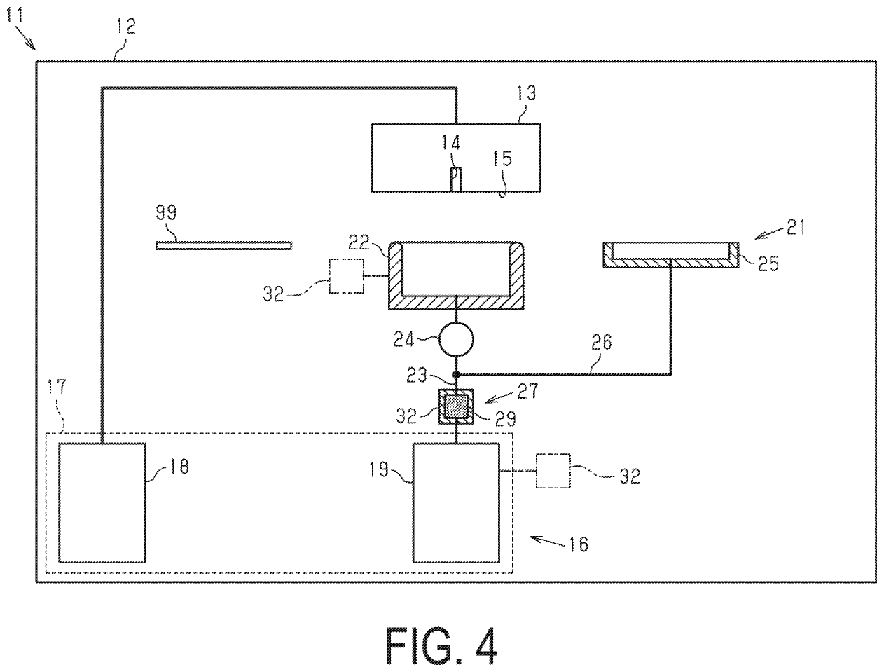

As illustrated in FIG. 4, the dehumidification portion 27 may include a dehumidifier accommodation body 32, instead of the dehumidifier accommodation portion 28. The dehumidifier accommodation body 32 is configured to accommodate the dehumidifier 29. The dehumidifier accommodation body 32 is, for example, a case.

The dehumidifier accommodation body 32 is located inside the housing 12. The dehumidifier accommodation body 32 is coupled to, for example, any one of the liquid accommodation portion 16, the cap 22, and the atmosphere flow path 23. Specifically, the dehumidifier accommodation body 32 is coupled to any one of the moisturizing accommodation portion 19, the cap 22, and the atmosphere flow path 23. The dehumidifier 29 dehumidifies the atmosphere in any of inside the moisturizing accommodation portion 19, inside the cap 22, and inside the atmosphere flow path 23. Accordingly, the atmosphere inside the cap 22 is dehumidified. Therefore, the atmosphere inside the cap 22 contains the vaporized solvent and is brought into a dehumidified state.

In the example illustrated in FIG. 4, the dehumidifier accommodation body 32 is coupled to the atmosphere flow path 23. Specifically, the dehumidifier accommodation body 32 is located in the middle of the atmosphere flow path 23. Therefore, the vaporized solvent passes through the dehumidifier 29 in a process of being supplied from the moisturizing accommodation portion 19 to the cap 22. The dehumidifier accommodation body 32 may be coupled to the moisturizing accommodation portion 19 or may be coupled to the cap 22.

The dehumidifier accommodation body 32 is not limited to being coupled to any one of the liquid accommodation portion 16, the cap 22, and the atmosphere flow path 23, and may be attached to the housing 12, for example. In this case, the dehumidifier accommodation body 32 dehumidifies the atmosphere inside the housing 12. The inside of the liquid accommodation portion 16, the inside of the cap 22, and the inside of the atmosphere flow path 23 communicate with the inside of the housing 12. Therefore, by the atmosphere inside the housing 12 being dehumidified, the atmosphere inside the liquid accommodation portion 16, inside the cap 22, inside the atmosphere flow path 23, or the like is also dehumidified. That is, the atmosphere inside the cap 22 is dehumidified. As a result, the atmosphere inside the cap 22 contains the vaporized solvent and is brought into a dehumidified state.

The dehumidifier accommodation body 32 may be configured to be detachable. Specifically, the dehumidifier accommodation body 32 is detachable from a coupling target. Accordingly, the dehumidifier 29 can be replaced. In one example, the dehumidifier accommodation body 32 is detachable from the atmosphere flow path 23.

### Operation and Effects

Next, an operation and effects of the liquid ejection device 11 described above will be described.

(3-1) The dehumidification portion 27 includes the dehumidifier accommodation body 32. According to the above configuration, the atmosphere inside the cap 22 is dehumidified by the dehumidifier 29.

(3-2) The dehumidifier accommodation body 32 is configured to be detachable. Specifically, the dehumidifier accommodation body 32 is detachable from the atmosphere flow path 23. According to the above configuration, the dehumidifier 29 can be replaced by removing the dehumidifier accommodation body 32.

### Fourth Embodiment

Next, a fourth embodiment of the liquid ejection device 11 will be described. In the fourth embodiment, differences from the first embodiment described above will be mainly described.

### Dehumidification Portion

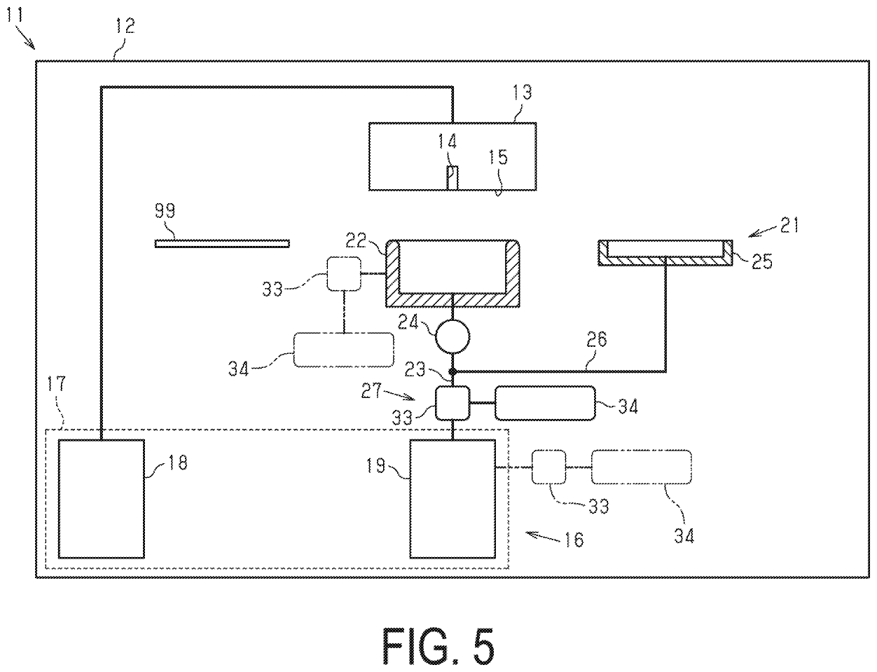

As illustrated in FIG. 5, the dehumidification portion 27 may dehumidify the atmosphere by supplying not only the dehumidifier 29 but also dry air. In one example, the dehumidification portion 27 includes a dry air supply mechanism 33. The dry air supply mechanism 33 is a mechanism that supplies dry air. The dry air supply mechanism 33 includes, for example, a fan or a pump. Accordingly, the dry air supply mechanism 33 sends the dry air.

The dry air may be air that has dehumidified an atmosphere containing the vaporized solvent, or may be air that has dehumidified an atmosphere not containing the vaporized solvent. The dry air supply mechanism 33 may supply the dry air that dehumidifies the atmosphere inside the liquid accommodation portion 16, inside the cap 22, and inside the atmosphere flow path 23, or may supply dry air that dehumidifies an atmosphere inside the housing 12 or outside the housing 12. The dry air supply mechanism 33 supplies dry air generated by a dry air generation mechanism 34 to be described below.

In the example illustrated in FIG. 5, the dry air supply mechanism 33 supplies dry air into at least any one of the liquid accommodation portion 16, the cap 22, and the atmosphere flow path 23. The dry air supply mechanism 33 is coupled to the atmosphere flow path 23, for example. The dry air supply mechanism 33 may be coupled to the liquid accommodation portion 16 or may be coupled to the cap 22. The dry air supply mechanism 33 dehumidifies the atmosphere inside the cap 22 by supplying the dry air into at least any one of the liquid accommodation portion 16, the cap 22, and the atmosphere flow path 23.

When the dry air supply mechanism 33 supplies dry air that does not contain the vaporized solvent, the inside of the cap 22 is replaced with the dry air, so that an amount of solvent contained in the atmosphere inside the cap 22 is reduced. In this case, an amount of water vapor contained in the atmosphere inside the cap 22 also decreases. Accordingly, as a result, the atmosphere inside the cap 22 contains the vaporized solvent and is brought into a dehumidified state.

The dry air supply mechanism 33 may supply the dry air into the cap 22. In one example, the dry air supply mechanism 33 supplies the dry air into the cap 22 from the moisturizing accommodation portion 19. Accordingly, the atmosphere inside the cap 22 is effectively dehumidified.

The liquid ejection device 11 is configured to introduce the dry air from the dry air generation mechanism 34. Specifically, the dry air supply mechanism 33 introduces the dry air from the dry air generation mechanism 34. The dry air generation mechanism 34 may be included in the liquid ejection device 11 or may be configured separately from the liquid ejection device 11.

The dry air generation mechanism 34 is configured to generate the dry air. The dry air generation mechanism 34 cools the introduced atmosphere to condense the water vapor in the atmosphere. Accordingly, the dry air generation mechanism 34 dehumidifies the introduced atmosphere. The dry air generation mechanism 34 generates the dry air by returning the cooled atmosphere to a room temperature. The dry air generation mechanism 34 cools the introduced atmosphere using a refrigerant, for example. The refrigerant is water, gas, or the like. The dry air generation mechanism 34 returns the cooled atmosphere to a room temperature, for example, by causing heat to be exchanged between the introduced atmosphere and the cooled atmosphere.

The dry air generation mechanism 34 supplies the generated dry air to the dry air supply mechanism 33. In one example, the dry air generation mechanism 34 is coupled to the dry air supply mechanism 33. Accordingly, the dry air generation mechanism 34 can effectively supply the dry air to the dry air supply mechanism 33.

The dry air generation mechanism 34 may generate the dry air from the atmosphere introduced through the dry air supply mechanism 33, or may generate the dry air from the atmosphere introduced without through the dry air supply mechanism 33. The dry air generation mechanism 34 may generate the dry air from the atmosphere containing the vaporized solvent, or may generate the dry air from the atmosphere that does not contain the vaporized solvent. That is, the dry air generation mechanism 34 may generate the dry air from the atmosphere inside the liquid accommodation portion 16, inside the cap 22, and inside the atmosphere flow path 23, or may generate the dry air from the atmosphere inside the housing 12 or outside the housing 12.

Operation and effects Next, an operation and effects of the liquid ejection device 11 described above will be described.

(4-1) The dehumidification portion 27 includes the dry air supply mechanism 33 that supplies the dry air. According to the above configuration, the atmosphere inside the cap 22 is dehumidified by the dry air.

(4-2) The dry air supply mechanism 33 supplies the dry air into the cap 22. According to the above configuration, the atmosphere containing the vaporized solvent effectively fills the inside of the cap 22 in a dehumidified state.

### Modification Examples

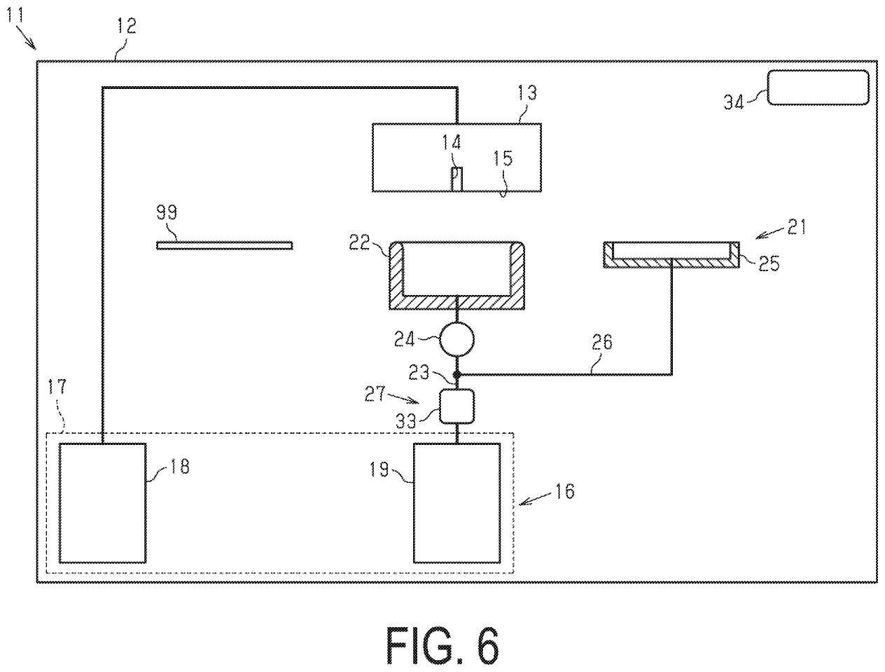

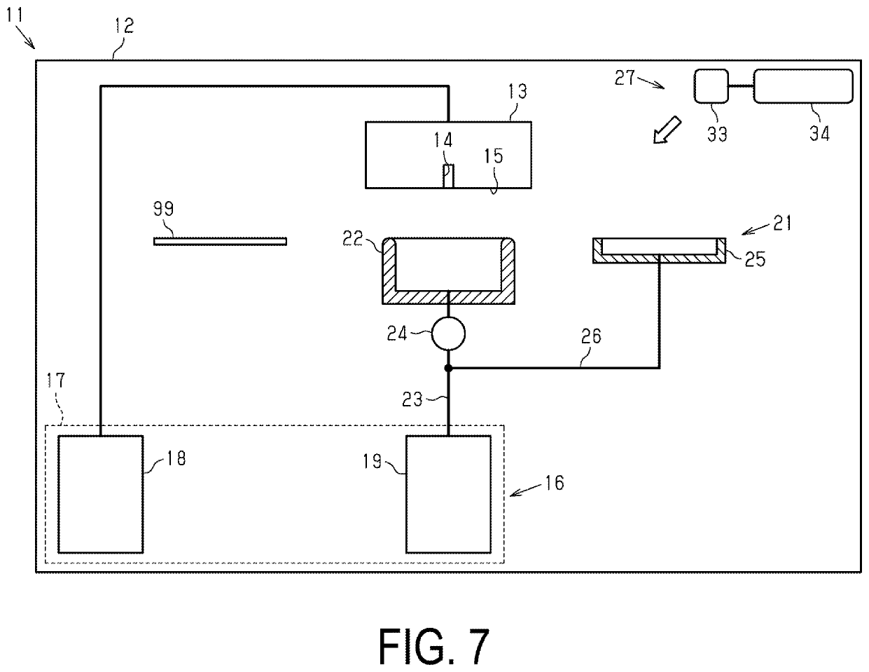

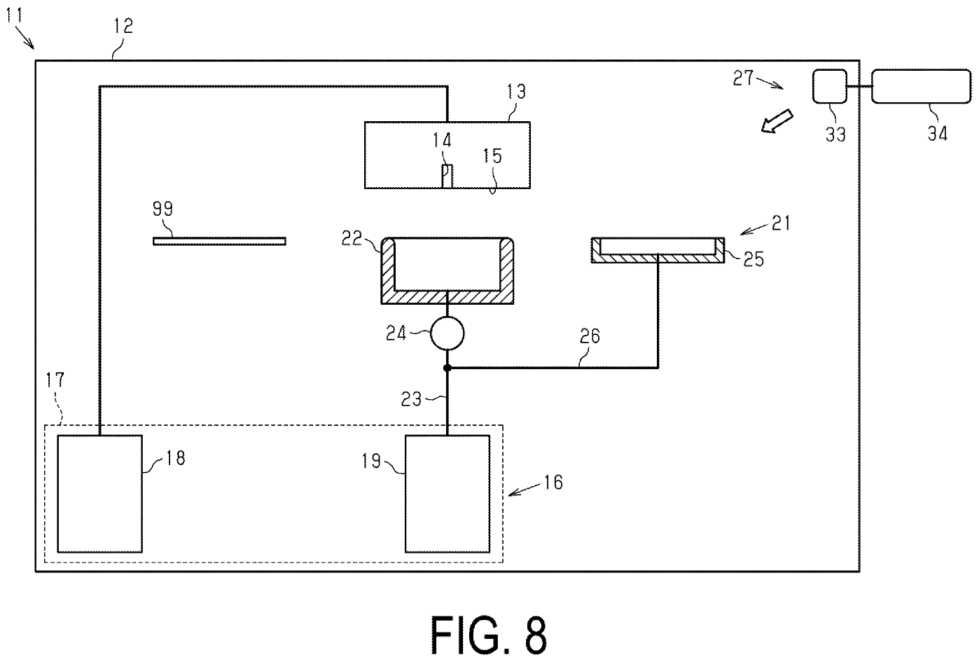

The first to fourth embodiments can be modified as follows. The above embodiments and the following modification examples can be combined with each other within a technically consistent range.
As illustrated in FIG. 6, the dry air generation mechanism 34 may not be coupled to the dry air supply mechanism 33. The dry air generation mechanism 34 is located inside the housing 12, for example. In this case, the dry air generated by the dry air generation mechanism 34 is supplied into the housing 12. By the dry air supply mechanism 33 introducing the dry air inside the housing 12, the atmosphere inside the cap 22 contains the vaporized solvent and is brought into a dehumidified state.
As illustrated in FIG. 7, the dry air supply mechanism 33 may not be coupled to any one of the liquid accommodation portion 16, the cap 22, and the atmosphere flow path 23. The dry air supply mechanism 33 supplies the dry air into the housing 12. The inside of the liquid accommodation portion 16, the inside of the cap 22, and the inside of the atmosphere flow path 23 communicate with the inside of the housing 12. Therefore, by the inside of the housing 12 being filled with the dry air, the atmosphere inside the liquid accommodation portion 16, inside the cap 22, inside the atmosphere flow path 23, or the like is also filled with the dry air. That is, the atmosphere inside the cap 22 is dehumidified. The dry air supply mechanism 33 may supply the dry air into the cap 22. The dry air supply mechanism 33 may, for example, supply the dry air in a direction indicated by a white arrow in FIG. 7. The dry air may be introduced from an opening of the receiving portion 25, an opening of the liquid accommodation portion 16, or the like.
As illustrated in FIG. 8, the dry air generation mechanism 34 may be located outside the housing 12. The dry air generation mechanism 34 may generate dry air from the atmosphere outside the housing 12. The dry air supply mechanism 33 may introduce the dry air into the housing 12 from outside the housing 12. Accordingly, the inside of the housing 12 is filled with the dry air. As a result, the atmosphere inside the cap 22 is dehumidified. The dry air supply mechanism 33 may supply the dry air toward the cap 22. The dry air supply mechanism 33 may, for example, supply the dry air in a direction indicated by a white arrow in FIG. 8.
When the liquid ejection device 11 includes the liquid accommodation portion 16, the dehumidifier accommodation portion 28 may be located inside the liquid accommodation portion 16. That is, the liquid accommodation portion 16 may include the dehumidification portion 27. In this case, the atmosphere in the liquid accommodation portion 16 is dehumidified by the dehumidifier 29. As a result, the atmosphere inside the cap 22 is dehumidified.

### Technical Spirit

Hereinafter, technical spirit and effects thereof ascertained from the above-described embodiments and modification examples will be described.

(A) A liquid ejection device is a liquid ejection device to which a liquid accommodation portion configured to accommodate a liquid containing a solvent is attached, the liquid ejection device including: a liquid ejection portion in which a nozzle configured to eject the liquid is open; a cap configured to form a space communicating with the nozzle by coming into contact with the liquid ejection portion; an atmosphere flow path coupled to the liquid accommodation portion and the cap; and a dehumidification portion configured to dehumidify an atmosphere inside at least any one of the liquid accommodation portion, the cap, and the atmosphere flow path.

According to the above configuration, the vaporized solvent is supplied from the liquid accommodation portion to the cap through the atmosphere flow path. Since the liquid accommodation portion, the cap, and the atmosphere flow path are coupled to each other, the atmosphere inside the cap is dehumidified by the dehumidification portion dehumidifying any one of the atmospheres. Therefore, the atmosphere inside the cap contains the vaporized solvent and is in a dehumidified state. Therefore, concern that the nozzle is clogged is reduced.

(B) The liquid ejection device may include: a suction portion located in the atmosphere flow path and configured to suck the liquid discharged from the nozzle to the cap,

wherein the liquid accommodation portion accommodates the liquid sucked by the suction portion. According to the above configuration, the nozzle can be moisturized by the solvent contained in the liquid discharged to the cap. That is, the liquid discharged to the cap can be reused for moisturization of the nozzle.

(C) The liquid ejection device may include a receiving portion configured to receive the liquid discharged from the nozzle; and a coupling flow path coupled to the atmosphere flow path and the receiving portion, wherein the liquid accommodation portion may accommodate the liquid received by the receiving portion. According to the above configuration, the nozzle can be moisturized by the solvent contained in the liquid received by the receiving portion. That is, the liquid received by the receiving portion can be reused for moisturization of the nozzle.

(D) The liquid ejection device may include a suction flow path coupled to the liquid accommodation portion and the cap; and a suction portion located in the suction flow path and configured to suck the liquid discharged from the nozzle to the cap, wherein the liquid accommodation portion may accommodate the liquid sucked by the suction portion. According to the above configuration, the nozzle can be moisturized by the solvent contained in the liquid discharged to the cap. That is, the liquid discharged to the cap can be reused for moisturization of the nozzle.

(E) The liquid ejection device may include: a receiving portion configured to receive the liquid discharged from the nozzle; and a coupling flow path coupled to the suction flow path and the receiving portion, wherein the liquid accommodation portion may accommodate the liquid received by the receiving portion. According to the above configuration, the nozzle can be moisturized by the solvent contained in the liquid received by the receiving portion. That is, the liquid received by the receiving portion can be reused for moisturization of the nozzle.

(F) In the liquid ejection device, the dehumidification portion may include a dehumidifier accommodation portion configured to accommodate a dehumidifier, and the dehumidifier accommodation portion may be located in the cap. According to the above configuration, the atmosphere inside the cap is dehumidified by the dehumidifier.

(G) In the liquid ejection device, the dehumidification portion may include a dehumidifier accommodation body configured to accommodate a dehumidifier. According to the above configuration, the atmosphere inside the cap is dehumidified by the dehumidifier.

(H) In the liquid ejection device, the dehumidifier accommodation body may be configured to be detachable. According to the above configuration, the dehumidifier can be replaced by removing the dehumidifier accommodation body.

(I) In the liquid ejection device, the dehumidification portion may include a dry air supply mechanism configured to supply dry air. According to the above configuration, the atmosphere inside the cap is dehumidified by the dry air.

(J) In the liquid ejection device, the dry air supply mechanism may supply the dry air toward the cap. According to the above configuration, the atmosphere inside the cap is effectively dehumidified by the dry air.

What is claimed is:

1. A liquid ejection device to which a liquid accommodation portion configured to accommodate a liquid containing a solvent is attached, the liquid ejection device comprising:
a liquid ejection portion in which a nozzle configured to eject the liquid is open;
a cap configured to form a space communicating with the nozzle by coming into contact with the liquid ejection portion;
an atmosphere flow path coupled to the liquid accommodation portion and the cap; and
a dehumidification portion configured to dehumidify an atmosphere inside at least any one of the liquid accommodation portion, the cap, and the atmosphere flow path.

2. The liquid ejection device according to claim 1, wherein the dehumidification portion dehumidifies the atmosphere inside the cap.

3. The liquid ejection device according to claim 1, comprising:
a suction portion located in the atmosphere flow path and configured to suck the liquid discharged from the nozzle to the cap,
wherein the liquid accommodation portion accommodates the liquid sucked by the suction portion.

4. The liquid ejection device according to claim 3, comprising:
a receiving portion configured to receive the liquid discharged from the nozzle; and
a coupling flow path coupled to the atmosphere flow path and the receiving portion,
wherein the liquid accommodation portion accommodates the liquid received by the receiving portion.

5. The liquid ejection device according to claim 1, comprising:
a suction flow path coupled to the liquid accommodation portion and the cap; and
a suction portion located in the suction flow path and configured to suck the liquid discharged from the nozzle to the cap,
wherein the liquid accommodation portion accommodates the liquid sucked by the suction portion.

6. The liquid ejection device according to claim 5, comprising:
a receiving portion configured to receive the liquid discharged from the nozzle; and
a coupling flow path coupled to the suction flow path and the receiving portion,
wherein the liquid accommodation portion accommodates the liquid received by the receiving portion.

7. The liquid ejection device according to claim 1,
wherein the dehumidification portion includes a dehumidifier accommodation portion configured to accommodate a dehumidifier, and
the dehumidifier accommodation portion is located in the cap.

8. The liquid ejection device according to claim 1, wherein the dehumidification portion includes a dehumidifier accommodation body configured to accommodate a dehumidifier.

9. The liquid ejection device according to claim 8, wherein the dehumidifier accommodation body is configured to be detachable.

10. The liquid ejection device according to claim 1, wherein the dehumidification portion includes a dry air supply mechanism configured to supply dry air.

11. The liquid ejection device according to claim 10, wherein the dry air supply mechanism supplies the dry air into the cap.
